(19) United States
(12) Patent Application Publication
(10) Pub. No.: US 2015/0343403 A1
(43) Pub. Date: Dec. 3, 2015

(54) ELECTRONIC REMOTE CONTROL MIXING SYSTEM, ASSOCIATED DEVICES AND METHODS

(71) Applicant: Sioux Automation Center Inc., Sioux Center, IA (US)

(72) Inventors: Joseph Ruhland, Hinton, IA (US); James Koch, Sioux Falls, SD (US); Ronald Hulshof, Sioux Center, IA (US)

(21) Appl. No.: 14/724,418

(22) Filed: May 28, 2015

Related U.S. Application Data
(60) Provisional application No. 62/003,839, filed on May 28, 2014.

(51) Int. Cl. B01F 15/00; G05B 15/02; A01K 5/00

(52) U.S. Cl. CPC B01F 15/00305; A01K 5/00; G05B 15/02

(57) ABSTRACT

The disclosed apparatus, systems and methods relate to a remote control system for mixing equipment operated by an operator. The remote unit is used to control powered mixing equipment associated with a loading vehicle having an operator station. The remote unit is in communication with the mixing equipment and is operable by the operator to control a mixing cycle of the mixing equipment without the need for the operator to leave the loading vehicle. The mixing cycle is set to mix the material in the mixing equipment either the same number of revolutions of the mixing equipment for each load or for the same amount of elapsed time to reduce variations in the ending mixed product from load to load.

### CROSS-REFERENCE TO RELATED APPLICATION(S)

This application claims priority to U.S. Provisional Application No. 62/003,839 filed May 28, 2014 and entitled “Electronic Remote Control Mixing System,” which is hereby incorporated by reference in its entirety under 35 U.S.C. §119(e).

### TECHNICAL FIELD

The disclosure relates generally to animal feed mixing systems and, more specifically, to an electronic remote control system for animal feed mixers for improving the ease and efficiency of controlling such mixers.

### BACKGROUND

The disclosure relates to apparatus, systems and methods for remote operation of a mechanical implement, such as a feeder mixer.

The principal objective in feed mixing is to assure that an animal receives all of its formulated nutrient allowances every day. Most feed manufacturers use the coefficient of variation or CV to measure mixer performance and mixture uniformity. The CV is defined as (100× standard deviation)/mean. A 5% CV is the industry standard for most ingredients. An ingredient mix CV of 5% permits that an animal receive at least 90% of its formulated dietary allowances 95% of the time.

Many of the problems in feed mixing are due to differences among feed ingredients in particle shape, size, and density. Feed ingredients with similar sizes and densities tend to blend easily and quickly. For example, ground or cracked grains have densities similar to that of the oilseed meals. Consequently, there is usually very little difficulty in obtaining a uniform blend of these feed ingredients. Minerals on the other hand have densities which are vastly greater than that of grains and oilseed meals. Drugs have intermediate densities, but very fine particle sizes. Forages have low densities, and highly varied particle shapes and sizes. This diversity of physical form and density of individual feed ingredients complicates the preparation of uniform feed mixes. The ability to control feed mixers carefully and consistently is important to deliver animal feed rations that meet a desired CV and are uniform and consistent and at the same time improve fuel efficiency while reducing the operator time required to prepare a ration.

Current feed mixers require that the operator allows the feed mixer to run constantly during the loading sequence, even with no material in the mixer, or manually exit the loading vehicle to start the feeder mixer and allow it to mix the ingredients for a defined period of time or enough to level the loaded ingredients in order to add more material to the feeder mixer. Allowing the mixer to operate constantly creates added wear to the machine and uses excessive amounts of fuel. Manually starting and stopping the mixer during the loading cycle is a highly labor intensive and time consuming operation.

Prior to the remote mixing control concept, manufacturers of agricultural equipment and farm operators have been working with revolution counters, timers, and remote controls for various applications for years. For example, a well known scale manufacturer has products available for feeder mixers that accurately count mixer auger revolutions and mixing times and display that information to the operator. These are both manually controlled counters and timers and the operator is required to be present to be able to stop the mixing cycle. These advancements in the scale industry have come about recently with the advancements in scale head technology and touch screen displays. Farm equipment manufacturers have used remote mounted switches and buttons to activate power unit drive systems while the operator is away from the power unit or operators station. Farm equipment manufacturers have also created a remote control activation system that is targeted to the custom liquid manure application industry.

The system allows an operator to remotely engage the power unit drive system, operate several hydraulic functions, and increase or decrease the power unit engine speed. In the prior art, all of these functions are manually controlled and have no automation features built into the systems. For years, farm operators have been creating ways and methods to save time and increase profits by automating or remotely operating machinery. The largest shares of these ideas come in the area of agricultural tractors operating grain augers or conveyors during harvest. Operators have placed remotely mounted control boxes on the grain augers, conveyors, or on the external surfaces of the tractor to operate the PTO, hydraulics, engine speed, and to start and stop the engine. All of these concepts are novel for those particular segments, but none have fully automated the way the functions are operated, as each and every one of the functions described above require an operator to manually control both the start and stop of each function. This leads to the operator still being responsible for the final product of each concept. For example, if the operator is utilizing a revolution counter, the operator is responsible for stopping the mixing cycle at a certain time. The operator could be distracted and allow the feeder mixer to run its mix cycle too long in this instance, resulting in an over processed batch of feed. Another example would be a remote controlled tractor that is running a liquid manure pump that is loading manure tanks. If the operator starts the tractor remotely to fill the tank and becomes distracted or walks away from the equipment the tank could become full and spill before the operator has the ability to remotely turn the manure pump off with the remote control.

Others who have attempted to create a uniform and equal finished mix of materials have relied on revolution counters or timers as a part of a manually controlled system. The operator is required to engage the mixing cycle and allow the revolution counter or timer to begin counting. When the appropriate number of revolutions or time has elapsed, the operator then needs to manually stop the mixing cycle. This requires the operator to be at the controls of the feeder mixer during this time.

With the operator exiting the loading vehicle to begin the mixing cycle once or multiple times per load in an effort to save fuel usage of the feeder mixer power unit, the amount of time the operator spends traveling back and forth to the loading vehicle typically outweighs any monetary savings of the fuel usage of the mixing power unit. By running the feeder mixer manually from inside of the cab or at the controls by letting the feeder mixer mix while the operator is outside of the cab and in the loading vehicle, the feeder mixer revolution counts cannot be ensured to be equal from load to load to make a completely mixed product that is not over processed or under processed. If the operator only starts the mixing cycle when in the cab or by the controls to observe the revolution counts or timer, the operator is still required to manually control the start and stop points of the mixing cycle.

There is a need in the art for improved systems, methods, and apparatus for the remote mixing of feed.

### BRIEF SUMMARY

Discussed herein are various systems, methods, and apparatus for the remote mixing of feed

In Example 1, a remote mixer system comprises a feeder mixer, a remote control unit further comprising control software, a communications unit, and an operations unit, wherein the remote control unit is in communication with the feeder mixer and configured to be operable remotely.

Example 2 relates to Example 1, wherein the remote control unit further comprises at least one user interface.

Example 3 relates to Example 1, wherein the communications unit further comprises at least one transmitter and at least one receiver.

Example 4 relates to Example 1, wherein the operations unit further comprises a power unit control interface, a power unit, and a drive system.

Example 5 relates to Example 1, wherein the remote control unit further comprises at least one user interface, the communications unit further comprises at least one transmitter and at least one receiver, and the operations unit further comprises a power unit control interface, a power unit, and a drive system in operational communication with the feeder mixer.

Example 6 relates to Example 2, wherein the remote control unit further comprises a graphical user interface.

Example 7 relates to Example 6, further comprising a touch screen.

Example 8 relates to Example 2, wherein the remote control unit further comprises a handheld unit and an in-cab unit.

In Example 9, a remote mixer system, comprising a remote control unit further comprising control software a communications unit, and an operations unit, wherein the remote mixer system can be installed on a feeder mixer, and further wherein operations unit is in operable control of the feeder mixer and the remote control unit is in operational communication with the operations unit by way of the communications unit.

Example 10 relates to Example 9, wherein the remote control unit further comprises at least one user interface and control software.

Example 11 relates to Example 10, wherein the remote control unit further consists of at least one of a handheld unit and an in-cab unit.

Example 12 relates to Example 9, wherein the communications unit further comprises a transmitter and a receiver and the operations unit further comprises a power unit control interface, a power unit, and a drive system, and the receiver is in operational communication with the power unit control interface.

Example 13 relates to Example 9, further comprising at least one sensor.

Example 14 relates to Example 9, further comprising a GPS system.

Example 15 relates to Example 9, further comprising a revolutions counter.

Example 16 A method of remotely operating a feeder mixer, comprising providing a remote control unit, a communications unit and a operations unit which are operationally integrated into the feeder mixer, wherein the feeder mixer is attached to a vehicle, operating the feeder mixer by way of the remote control unit.

Example 17 relates to Example 16, wherein the remote control unit further comprises a user interface and control software.

Example 18 relates to Example 17, wherein the remote control unit is handheld.

Example 19 relates to Example 17, wherein the remote control unit further comprises a graphical user interface and a touch screen.

Example 20 relates to Example further comprising a revolutions counter.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a side view of an exemplary embodiment of the system on a vehicle.

FIG. 1B is a cutaway side view of an exemplary embodiment of the system installed on a vehicle.

FIG. 2A is a schematic overview of the various components of the system according to an exemplary embodiment.

FIG. 2B is a schematic overview of various components of the system according to a further exemplary embodiment.

FIG. 3A depicts a schematic of an exemplary embodiment of the system utilizing a handheld remote unit.

FIG. 3B depicts a schematic of an alternative exemplary embodiment of the system utilizing a touch screen control.

FIG. 4 depicts a flowchart of system operation according to an exemplary embodiment.

### DETAILED DESCRIPTION

The various embodiments of the remote mixing control system, or “system,” allow a user or operator to have full control over the feeder mixer mixing cycle without the need to leave the loading vehicle or batch station to manually control the feeder mixer. The system also allows the operator to mix the material for the same or similar duration (or number of auger revolutions) for each successive load with little to no variation in the resulting mixed product. For brevity, the devices, systems and methods implicated by the various embodiments will be referred to herein as “remote mixing control system,” “mixing system,” and “system,” and the like, but the use of these terms is in no way intended to limit the disclosed embodiments to a specific modality.

Exemplary embodiments of the system comprise a remote control unit, a communications unit, and operations unit, whereby the user is able to utilize the remote control unit to effectuate action on the operations unit by way of the communications unit.

The development of the remote controlled feed mixer began with the development of a new control system and hydrostatic drive system for an existing line of feeder mixers. The present system was designed to monitor pressures, log data, and have interactive warning messages for the operator. In order to control the electronic pumps, a more sophisticated control system was required than had been previously used.

By being able to remotely control the feeder mixer power unit speed and mixing cycle engagement, the operator can be more efficient in the use of time loading the material into the feeder mixer and can also perform other tasks while the feeder mixer is completing its mixing cycle with the automated mix timer. The operator in this instance has gained not only the savings in fuel from the feeder mixer power unit and less wear on the machine but also increased the productivity by essentially being able to perform two tasks at once.

The system allows the operator to be more profitable by saving labor, fuel, and wear on the feeder mixer components, and can increase the longevity of the drive train components. Most beef feedlots and dairies use a feeder mixer of some sort to feed the livestock daily. Many of these feedlots and dairies feed animals for several hours per day, every day of the year. If this product offering shows a high return on investment for an operator, they will be more willing to pursue this option. The remote mixer control could be used in a wide range of styles of feeder mixers through a large range of types of feedlots and dairies over a large geographical area. This would be something that the operators would use every day to improve their profitability. Feeder mixers are also used in non livestock applications where any material is required to be mixed. For example, some are used for compost mixing, while some are used to process plastics for recycling. Other batch processing facilities that would benefit from this concept would be the aggregate market, asphalt batch loading, scrap crushing, bale processing, concrete mixing batch stations, and feed mills. The mixing apparatus in other branches of industry may vary slightly, but the principle of the remote mixing control system would remain the same.

Exposing this concept to other industries such as construction or modern mixing facilities could potentially increase profitability and reduce labor and equipment repair costs by operating the mixers only when required to do so. Accordingly, the remote mixing system is applicable to several industries.

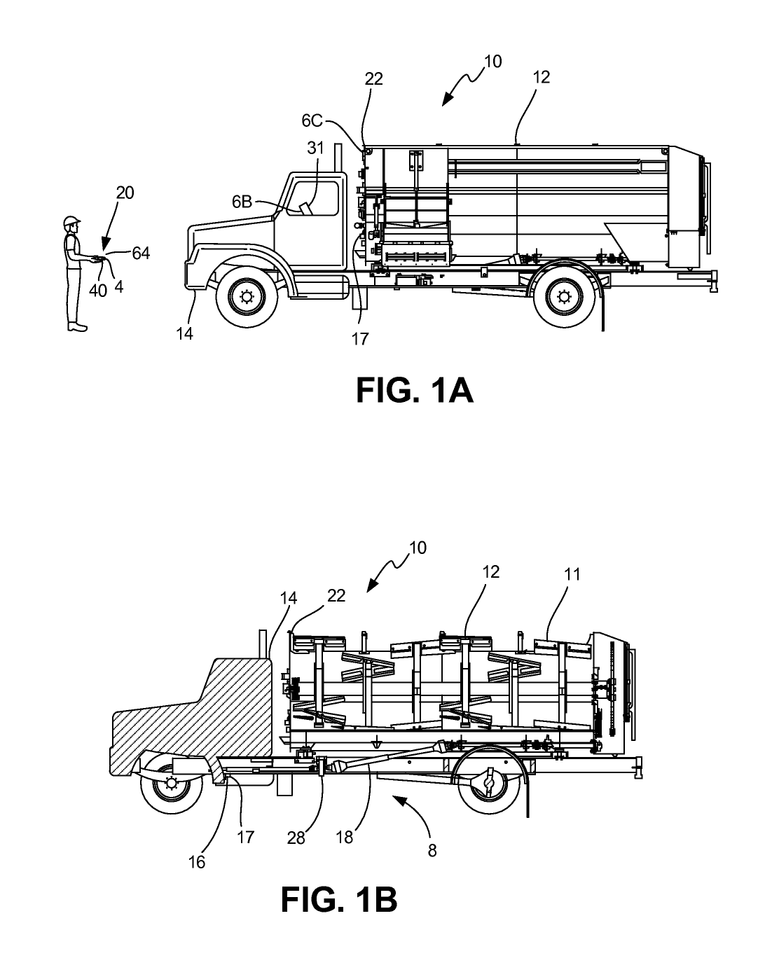

Turning to the drawings in greater detail, as is depicted in FIGS. 1A-B the system 10 comprises a feeder mixer 12 which is operated remotely by at least one user interface. In various embodiments, the feeder mixer 12 can be any variant of apparatus that is used to mix or process feedstuffs for livestock or other materials for any other purpose such as compost or plastic bottles for recycling. In certain exemplary embodiments, the feeder mixer is in operational communication with a vehicle 14, as is shown in FIG. 1A-1B. As is also shown in FIGS. 1A-1B, exemplary embodiments of the remote mixing system 10 comprise a remote control unit 4, a communications unit 6A, 6B, 6C, and a operations unit 8, which are in operational communication with one another such that the feeder mixer 12 may be operated remotely by way of the remote control unit 4. In exemplary embodiments, the remote control unit can further comprise a plurality of individual user interfaces, namely an in-cab unit 31 and a handheld unit 40.

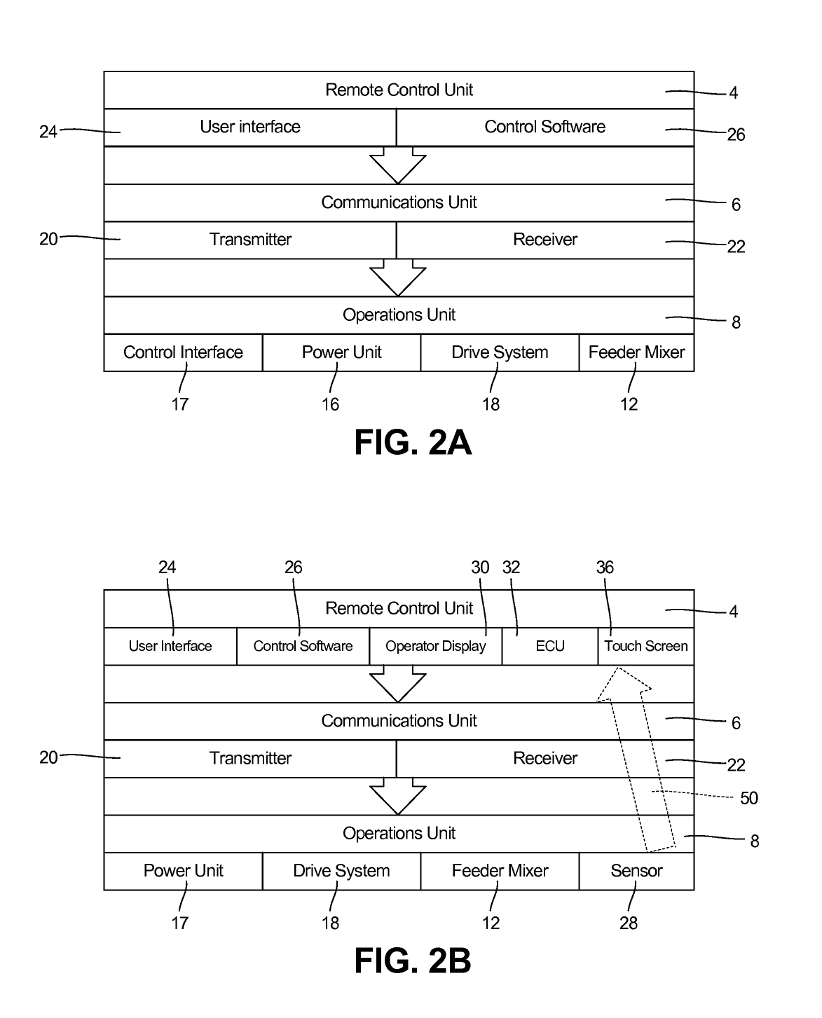

As is shown in FIG. 2A, in exemplary embodiments, the remote control unit 4 further comprises at least one user interface 24 and control software 26, which are in operational communication with the communications unit 6. The communications unit 6, in turn, comprises a remote transmitter 20, which is in operational communication with the remote control unit 4, and a receiver 22, which is disposed at or near the operations unit so as to be able to receive electronic communication from the remote transmitter 20 so as to power the operations unit 8.

As is shown in FIG. 1B, in exemplary embodiments the feeder mixer further comprise at least one auger 11 in operational communication with a drive mechanism (such as a PTO driveline), as would be apparent to one of skill in the art. In exemplary embodiments, the operations unit 8 comprises a power unit 16, a power unit control interface 17 and a drive system 18, these components in operational communication with the feeder mixer 12 so as to operate the feeder mixer 12. In typical embodiments, the power unit control interface 17 is mounted near the vehicle firewall (FIG. 1A) or in the chassis cab (FIG. 2B).

Exemplary feed mixers (or “grinder mixers”) include vertical type single and multiple mixing or processing auger feed mixers, feed mixers with single or multiple horizontal mixing or processing augers, and feed mixers with a combination of horizontally mounted mixing or processing auger(s) with a mixing reel. Other types of batch mixers may also be considered. These would include, but are not limited to concrete batch mixers, aggregate mixers, asphalt mixers, and scrap metal mixing devices. In certain embodiments, the mixer is loaded by a loading vehicle, namely any type of machine that places materials into the mixer which would include, but not be limited to a front end loader (payloader), an agricultural type tractor with a front end loader, a skid steer loader, a telehandler, an overhead bin, a batch box, or a dumping station. These machines can all vary in types, makes, models, capacities, and colors, as would be appreciated by one of skill in the art.

As is shown in FIG. 2B, in certain embodiments, the mixing system further comprises at least one sensor 28 in operational communication 50 with the remote control unit 4 so as to provide the user with feedback. In certain embodiments, the user interface 24 further comprises an operator display 30, and/or an electronic control unit (“ECU”) 32, though these are not essential to the function of the system in every embodiment. Certain exemplary embodiments further comprise a touch screen 36. In embodiments featuring handheld 40 and in-cab 31 units, these units are in wireless communication with one another by way of the communications unit 6, such that each may transmit and receive information with one another as well as the operations unit 8 (as is also shown in FIG. 1A at 6A, 6B, 6C). In exemplary embodiments, memory and/or an ECU is in operational communication with one or both of the units 40, 31, as is best shown in FIG. 1A.

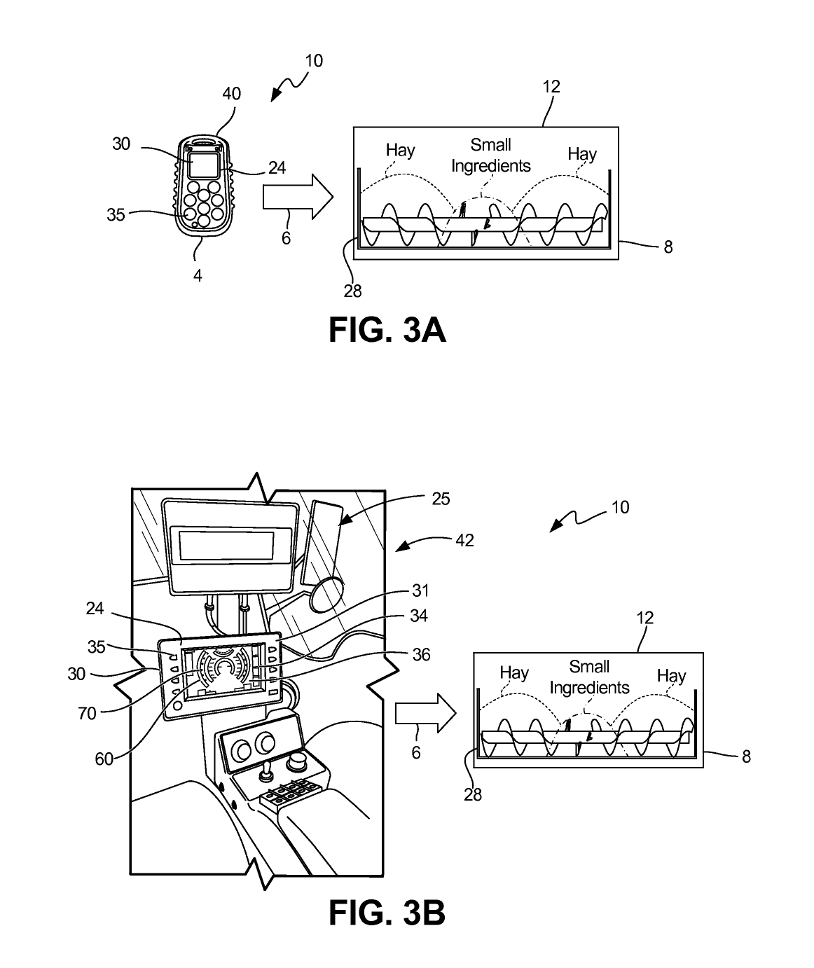

In certain embodiments, a wireless handheld remote 40 is utilized as a first user interface 24 and operator display 30 to control the feeder mixer, as is shown in FIG. 3A. As is shown in FIG. 3B, certain embodiments further comprise a second user interface 25 comprising a second operator display 31 further comprising a graphical user interface (“GUI”) 34. As is also shown in FIG. 3B, in certain embodiments, the user interface may be mounted inside the cab 42 of the vehicle. In further embodiments, either user interface further comprises a touch screen 36, as is shown in FIG. 3B. Further embodiments are possible, such that in exemplary embodiments the remote control unit comprises both a handheld remote 40 and an in-cab operator display unit 31, which may further comprise a GUI 34 and touch screen 36. In various embodiments, physical buttons 35 or other mechanical actuation devices may also be employed on either user interface 24.

In exemplary embodiments, after the system boots or is otherwise initiated, the operator display 30 and/or GUI 34 will depict various system operating parameters 60 which may be provided by the various sensors 28. Accordingly, in certain embodiments, the hydrostatic pump system pressure, the hydrostatic pump charge pressure, hydraulic oil temperature, conveyor speed, and auger speed may be displayed. If, at any time during operation, hydraulic system or electrical system components fail for example, a warning message may be displayed alerting the user to the failure, such as by way of the GUI or other operator display. In certain embodiments, the system will not allow further operation without acknowledging the warning and taking appropriate action.

Returning to FIGS. 1B and 2A, in exemplary embodiments, the control software further comprises a revolution counter/timer 70. In exemplary embodiments, the user is able to define the mixing period, either by revolutions or time. By way of example, in one embodiment mixing at 36 RPM, if the operator wishes to have the remote setting run for 10 minutes, the user is able to use the operator display or other input component to set the revolution count at 360 revolutions (36 RPM×10 min=360 revolutions), or vice versa.

In certain embodiments, the system 10 can further comprise a variety of alternative safety and quality features. For example, in certain embodiments, certain features may be locked/unlocked in certain configurations. Examples of this would include limiting auxiliary hydraulic functions such as the discharge door, the conveyor slide, and/or the conveyor motor when in the remote mixing cycle. Any other hydraulically or electrically controlled function or option such as additional discharge doors or conveyors can also be automatically controlled, as would be readily apparent to one of skill in the art.

In various embodiments, the power unit 16 can vary based on type which would include, but is not limited to a truck chassis, agricultural type tractor, electric motor, or a stationary engine. These power units can vary based on manufacturer, size, make, model, configuration, and color.

The drive system 18 can vary by type which would include, but is not limited to a hydrostatic pump and hydraulic motor drive system, a mechanically operated drive system from the power unit, or a belt driven drive system from the power unit. Any combination of these drive systems can also be considered such as an electric motor powering a hydrostatic pump on a stationary mixer. These drive systems and components can vary by manufacturer, size, make, model, configuration, and color.

The transmitter 20 and receiver 22, as best shown in FIGS. 2A-B, can vary by manufacturer, size, shape, mounting style, or color as long as the transmitter can send wirelessly a signal to the receiver and the receiver can send an electrical output. In certain embodiments, the transmitter is handheld, as has been previously described.

The user interface 24 and/or operator display 30 can vary by manufacturer, model, size, shape, and functionality, as is discussed further herein. In certain exemplary embodiments, a GUI 34 and/or touch screen 36 is provided. In various embodiments, a combination of touch screen and button controls may be integrated into the user interface 24. In certain embodiments, the user interface 24 is configured to present a variety of programmable presets to introduce further efficiencies into the system. In further embodiments, the user interface 24 may comprise a lighted LED or color display to enhance operability and readability. In further embodiments, the user interface 24 further comprises memory and storage, as well as wireless communications components. In further embodiments, solid state components may be utilized. In certain embodiments, the user interface 24 can further comprise a battery and be docked and removed.

In various embodiments, the GUI 34 (such as the GUI depicted in FIG. 3B) allows for simpler and more integrated control of functional operations such that they can be dictated and monitored by positional, weight, and other sensor inputs and fault awareness integrated GPS, scale, control, and diagnostic interface, which provides the user with the ability to avoid error and increase efficiency and consistency. Certain exemplary embodiments of the system prompt and allow the user to control the rate, efficiency, and accuracy of feed placement within their operation with the use of the onscreen interactive words or symbols that display and control hydraulic actions, mixer actions, auto-steer, GPS mapping, camera views, scale information, and loading/unloading status, amongst other features. Operational real time feedback will only increase efficiency and accuracy within the mixing and feeding process.

In certain embodiments, the display 30 takes data from multiple sources, including but not limited to: a GPS receiver, a scale receiver or weigh bar direct source, cameras, the chassis, the engine, the PTO, and the sensors for speed, oil temperature and the mixer box, as well as others. Accordingly, the system is configured to give the user diagnostic information relating to weigh, the contents of the mixer, diagnostic information about the vehicle, the speed of various components, the temperature of various fluids, door or gate position information, the pressure of various components, the torque and power being generated, and the like. In these embodiments, the system is able to provide this information to the user as feedback, and gives the user the ability to execute commands in real-time to make adjustments and stay within pre-defined limits. Accordingly, the display offers input control that are either primary or secondary controls for these functions so that there is integral redundancy built into the operational controls to reduce downtime within the mixer control system. Thus, the display and system allows the operator to navigate to more in depth features and settings, for diagnostic and background variables.

In exemplary embodiments, the sensor(s) 28 can be any sensor that brings information back to the receiver or optional user display for interpretation. Those sensors can include, but not be limited to a speed sensor, such as any type of speed sensing apparatus that is able to send a frequency to an ECU or operator display to be converted to a revolution or speed. This may vary by manufacturer, size, model, color, and mounting style. Revolution counter devices may also be substituted for speed sensors. Further sensors such as oil temperature, oil pressure, voltage, and proximity sensors are also possible, depending on the specific implementation and use of the mixer.

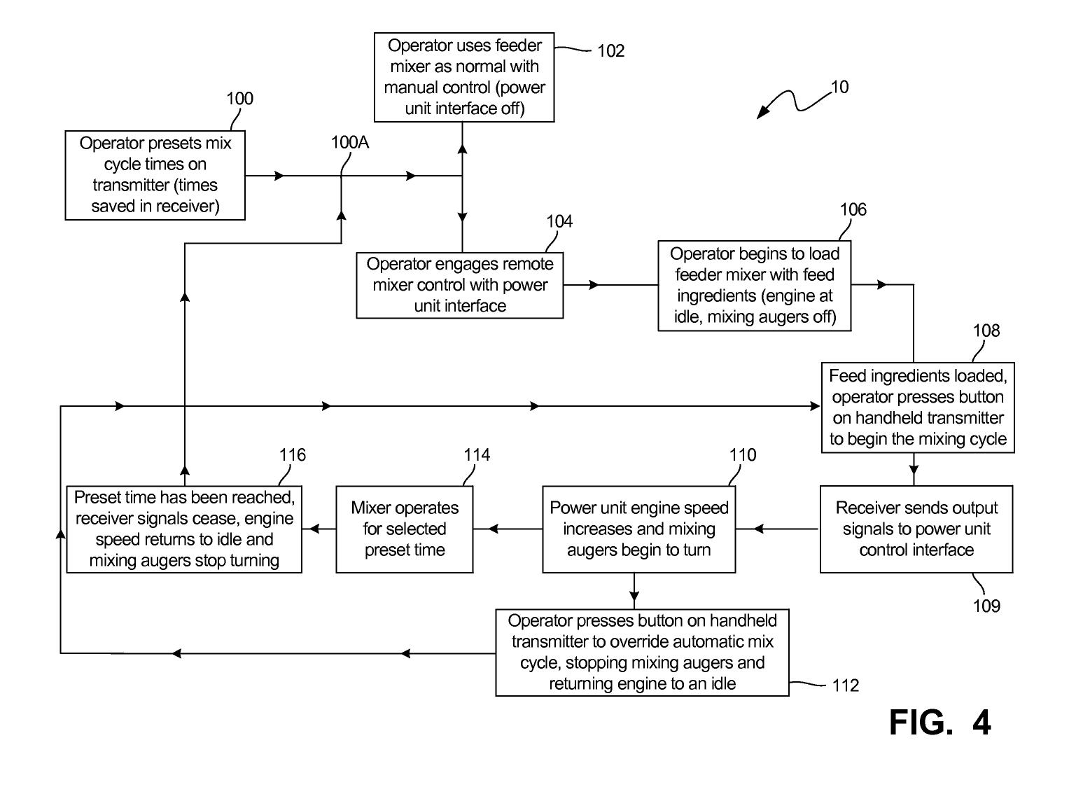

FIG. 4 depicts an exemplary process of operation of the system 10. In these embodiments, the user interacts with the remote control unit to preset a mix cycle 100, which is transmitted to the receiver by the transmitter as described in relation to FIGS. 1A-2B. The operator then has the option of operating the feeder mixer manually 102 or engaging the mixer by way of the remote unit 104. In this embodiment, the operator can now proceed to loading the feeder mixer 106, wherein the engine of the vehicle is operating at an idle, and the augers are off. Following loading, the user is able to interact with the remote control unit to initiate the mixing cycle 108. In so doing, the transmitter communicates with the receiver 109 and therefore the operations unit to effectuate any change or continued operation. In these embodiments, mixing will occur 110, and the user has the option to perform a manual override 112 to return to the loading step for example 106. In exemplary embodiments, after the mixer has operated 114 for the preset time/number of revolutions 116, the mixer is stopped and the process has completed, thereby returning the system to the beginning of the process 100A. As would be apparent to one of skill in the art, any number of other variations are possible without departing from the spirit of the disclosed invention.

In certain embodiments, the system comprises an ECU 32 that also be in operational communication with the user interface 24, depending upon the amount of logic that is used in the software programming. The ECU can vary by manufacturer, size, type, model, available inputs and outputs, and color. In certain embodiments, the ECU may be eliminated if the operator display or control panel has the programming capacity to allow all of the functions to be performed. Further embodiments comprise memory, such as a hard drive, as well as firmware. Various embodiments of the remote mixing control system can be adapted to any feeder mixer that is mounted to a truck chassis, towed with a farm type tractor, or a stationary feeder mixer that is powered by mechanical, hydraulic, or electrical means.

Exemplary embodiments of the remote control mixing system are intended to be used on a feeder mixer (used for a total mixed ration or TMR) using either an electrical, mechanical, or hydraulic drive system to power the mixing auger(s) of the feeder mixer. The purpose of the remote control mixing system is to allow the operator of the feeder mixer to increase the speed of the power unit to the recommended mixing speed and begin the mixing process remotely from the loading vehicle or machine after loading a certain amount (or pounds) of ingredients. After the mixing auger(s) have operated for a pre determined time (or number of revolutions), the feeder mixer will stop mixing and the power unit will return to an idle or turn off in the case of an electric motor. This system gives the operator the ability to mix ingredients consistently load after load by using the same mix time (or number of auger revolutions) and not over process or under process the materials. This system also improves the efficiency of fuel or electricity.

In exemplary embodiments, the remote control mixing system can be a combination of commercially available controls and a proprietary software program combined with an interface to a truck chassis, agricultural type tractor, a mobile unit pulled by a truck or tractor, or an electric motor that is able to signal the power unit to increase engine speed or turn an electric motor on and maintain the speed for a preset amount of time while at the same time signaling the feeder mixer auger drive system to engage to begin the mixing cycle.

The software of the receiver or user interface can also vary in its contents for the change in power unit, drive system, type of sensors, ECU (if required), and operator display that the remote will be controlling. The functions of the software allow the power unit and feeder mixer to be activated with a single button push of a remote. In certain embodiments this can also be accomplished by using two remote button pushes, of which one would be to activate the power unit, and the second to activate the feeder mixer to begin mixing. The mixing process can also be initiated by an outside signal being sent to the receiver or ECU such as a target weight in the mixer, GPS location, vehicle speed, or by time rather than manually pressing a transmitter button.

In exemplary embodiments, the software is in operational communication with a variety of components, such as the power unit, drive system, sensors, ECU, and operator display. In various embodiments, the software allows the power unit and feeder mixer to be activated by way of the operator in the location convenient for the operator, such as in a vehicle cab. In certain embodiments, the operator is able perform a variety of functions in sequence, such to activate the power unit, and activate the feeder mixer to begin mixing. The mixing process can also be initiated by an outside signal being sent to the receiver such as a target weight in the mixer, GPS location, vehicle speed, or by time.

In certain implementations, the feeder mixer is engaged through a power unit control interface 17. In certain embodiments, the interface and remote control unit can comprise a control box containing wires, switches, and other common electrical components, or it may be integrated into a touch screen user interface utilizing an ECU for added logic control and machine diagnostic capabilities for alternative implementations.

In certain embodiments, the functions of the remote mixer control itself are solely contained within the receiver and preset mixing times can be modified with the handheld remote transmitter. In these, the operator can choose from various settings, such as several different mix cycle times, and may choose to modify these values at any time to suit the operation of the feeder mixer in those embodiments. In exemplary embodiments, the range of settings is infinite. In certain embodiments, the system comprises memory, such that once the operator has chosen settings, they are saved and only need to be reprogrammed if the operator wishes to change them again.

In various embodiments, once the system has been engaged, the operator loads feed ingredients into the empty feeder mixer as the mixing auger(s) are not turning and with the power unit at an idle (or in alternative embodiments the electric motor is not turning). When the operator wishes to begin the mixing process the operator uses a handheld wireless remote transmitter equipped with several buttons (and in some embodiments a display on the transmitter) to activate the mixing cycle. By way of example, this can be because all of the ingredients are in the mixer, or the ingredients need to be mixed slightly to gain capacity in the mixer box for more ingredients, or various other reasons readily apparent to one of skill in the art.

In exemplary implementations, when the signal to initiate the mixing cycle is transmitted to the receiver and received, outputs are sent from the receiver to the power unit control interface, thereby signaling the mixer to engage the mixing cycle and the power unit to increase engine speed or activate the electric motor in embodiments utilizing an electric motor. In certain embodiments, the software within the receiver has the capability to have these two prior events occur at differing times so that the mixer is not engaging against a power unit at full speed and power, or allowing the power unit to increase speed to gain power prior to the mixer being engaged.

The power unit interface can be a combination of wiring, connectors, mechanical actuators, or commercially available control products depending on the make, model, and year of the truck chassis, agricultural type tractor, mobile unit coupleable with a tractor or truck, or electric motor.

When the mixing augers begin to turn, the receiver begins an internal time countdown of the mixing cycle that the operator has preset and chosen. During this time, in certain embodiments, values obtained from various sensors can be relayed back to the operator through the handheld transmitter or user interface. These values can also be recorded within the user interface or ECU and provide valuable history on the operation of the machine in the event of machine failure or other such scenarios. Sensor readings can range from oil temperature, oil pressure, mixing auger speed or revolutions turned, and the like.

During the mixing cycle, the operator can turn the mixing augers and the engine speed outputs off before the cycle is complete by using the handheld remote transmitter. If the operator allows the mixing cycle to complete automatically, when the preset time has been reached, the receiver stops sending the signals that engage the mixer and engine speed control to the power unit interface, thus allowing the mixing augers to stop turning and the power unit engine speed to return to a low idle or the electric motor to turn off. At this time, the feed in the mixer may be completely mixed and ready to be delivered, or the operator may choose to add more ingredients to the feeder mixer and remotely start the mixer again for a second mixing cycle (this can continue infinitely).

The system may also be engaged by means of a preset weight in the feeder mixer to activate the mixing cycle, by GPS position of a mobile feeder mixer, a combination thereof, or any other means of automatically engaging the remote mixing system.

The advantages to this system allow the operator to remotely start and stop the feeder mixer at predetermined intervals. This allows the operator to run the mixer and power unit only when needed, resulting in potential savings in fuel, maintenance, labor, or electricity savings for the operation since the power unit is not running empty at a high operating speed or under load unnecessarily. There is a time savings benefit for the operator as the operator does not need to exit the loading vehicle to start the mixer if the operator chooses to start the mixer after the feeder mixer has already begun to be loaded. The advantage of having a consistently mixed final product each and every load results in a feed mix that is not over processed nor under processed for high cost feed commodities. This is especially important for dairy feed rations, as a slight change in feed texture, mix, or other variation from the norm can result in a dramatic negative swing in milk production which may take weeks to recover from. The feeder mixer itself will last longer than a comparable feeder mixer loading the same loads without a remote control since the material in the mixer chamber will not be wearing on the components as much as it was if it were running all of the time during the loading process. Feeder mixer drive components will last longer as those components will not be operating as frequently.

Other features of the system include the ability to stop the mixing augers from turning and allow the power unit to return to an idle (or an electric motor to shut off) with the handheld remote prior to the end of the mixing cycle. If, for example, a tire that holds a tarp down on the top of a feedstuffs pile accidently gets dumped into the mixer while it is mixing, the operator can stop the feeder mixer from the loading vehicle in order to retrieve the tire from the mixer. This substantially increases the chances that the tire will not damage the mixer before the operator can shut the mixer down. If the operator was using the feeder mixer in the traditional manner, the operator would need to exit the loading vehicle and go to the power unit of the feeder mixer to power it down. During this time, the tire may have already become wedged in the augers under the material in the mixing chamber, possibly damaging the mixer or stalling the power unit. The remote control system can also be equipped with a range sensing device. If the handheld remote transmitter goes out of range of the feeder mixer, the mixer will stop mixing and the power unit will return to an idle or the electric motor will turn off before the preset mixing time has been reached. The handheld remote can also incorporate a feature that allows the mixer to stop mixing and return the power unit to an idle (or turn the electric motor off) if the battery on the remote transmitter dies.

In alternative embodiments, the remote mixer can operate three separate systems or methods to achieve the desired results. The first would be a simple revolution counter or timer that would be mounted to the mixer and display the revolutions or time to the operator. The operator would then need to manually turn the mixer off at the desired number of mixer revolutions or time to get the desired mix. The second alternative system for strictly addressing fuel or electricity savings would involve the operator beginning to load the feeder mixer when it is not in the mixing cycle. After loading several ingredients, the operator would leave the loading vehicle to start the mixer from the power unit. The operator would then need to reenter the loading vehicle to finish loading the materials. When the operator was finished loading the remaining ingredients, the operator would return to the mixer power unit and shut it off. This would add an extra trip to the mixer for the operator, questioning the fuel savings, as the mixer is running needlessly for the time that the operator is traveling to and from the loading vehicle. The third option would be to have a second operator at the power unit and controls of the feeder mixer while the first operator would load the feeder mixer. After several ingredients were loaded into the feeder mixer, the second operator would engage the mixing cycle and begin the revolution counter if so equipped. This system would allow the same benefits of the remote mixer control system, but at the cost of adding a second operator to the task at hand.

The remote mixing control system can be adapted to any feeder mixer that is mounted to a truck chassis, towed with a farm type tractor, or a stationary feeder mixer that is powered by mechanical, hydraulic, or electrical means.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

Although the disclosure has been described with reference to preferred embodiments, persons skilled in the art will recognize that changes may be made in form and detail without departing from the spirit and scope of the disclosed apparatus, systems and methods.

What is claimed is:

1. A remote mixer system, comprising:
a. a feeder mixer;
b. a remote control unit further comprising control software;
c. a communications unit; and
d. an operations unit;
wherein the remote control unit is in communication with the feeder mixer and configured to be operable remotely.

2. The system of claim 1, wherein the remote control unit further comprises at least one user interface.

3. The system of claim 1, wherein the communications unit further comprises at least one transmitter and at least one receiver.

4. The system of claim 1, wherein the operations unit further comprises a power unit control interface, a power unit, and a drive system.

5. The system of claim 1, wherein the remote control unit further comprises at least one user interface, the communications unit further comprises at least one transmitter and at least one receiver, and the operations unit further comprises a power unit control interface, a power unit, and a drive system in operational communication with the feeder mixer.

6. The system of claim 2, wherein the remote control unit further comprises a graphical user interface.

7. The system of claim 6, further comprising a touch screen.

8. The system of claim 2, wherein the remote control unit further comprises a handheld unit and an in-cab unit.

9. A remote mixer system, comprising:
b. a remote control unit further comprising control software;
c. a communications unit; and
d. an operations unit;
wherein the remote mixer system can be installed on a feeder mixer, and further wherein operations unit is in operable control of the feeder mixer and the remote control unit is in operational communication with the operations unit by way of the communications unit.

10. The system of claim 9, wherein the remote control unit further comprises at least one user interface and control software.

11. The system of claim 10, wherein the remote control unit further consists of at least one of a handheld unit and an in-cab unit.

12. The system of claim 9, wherein the communications unit further comprises a transmitter and a receiver and the operations unit further comprises a power unit control interface, a power unit, and a drive system, and the receiver is in operational communication with the power unit control interface.

13. The system of claim 9, further comprising at least one sensor.

14. The system of claim 9, further comprising a GPS system.

15. The system of claim 9, further comprising a revolutions counter.

16. A method of remotely operating a feeder mixer, comprising:
i. providing a remote control unit, a communications unit and a operations unit which are operationally integrated into the feeder mixer, wherein the feeder mixer is attached to a vehicle;
ii. operating the feeder mixer by way of the remote control unit.

17. The method of claim 16, wherein the remote control unit further comprises a user interface and control software.

18. The method of claim 17, wherein the remote control unit is handheld.

19. The method of claim 17, wherein the remote control unit further comprises a graphical user interface and a touch screen.

20. The method of claim 17, further comprising a revolutions counter.
